(19) United States
(12) Patent Application Publication
(10) Pub. No.: US 2019/0180653 A1
(43) Pub. Date: Jun. 13, 2019

(54) BADGE HOLDER WITH LANYARD AND MAGNETIC CLIP

(71) Applicant: Ivan TAN, Singapore (SG)

(72) Inventor: Ivan TAN, Singapore (SG)

(21) Appl. No.: 16/327,329

(22) PCT Filed: Jul. 26, 2017
(86) PCT No.: PCT/SG2017/050379

§ 371 Date: Feb. 22, 2019

(30) Foreign Application Priority Data
Aug. 22, 2016 (SG) 10201606956V

(51) Int. Cl. G09F 3/20

(52) U.S. Cl. CPC G09F 3/207

(57) ABSTRACT

The present invention is a badge holder with a lanyard and magnetic clip, as shown in FIG. 1. This invention will allow the user to simultaneously have the freedom of using the functions of the lanyard, and at the same time have the badge holder not sway around by using the magnetic clip. The clip will keep the badge holder right in front of the user's clothing, providing the user a clean and neat look. The badge holder is easy to fabricate as well, using two pieces of leather, a piece of fabric cloth and two pieces of magnets.

### BACKGROUND

### Field of the Invention

The present invention is a badge holder with a lanyard and magnetic clip.

### Description of the Related Art

One of the most popular ways to bring around a badge holder is via a lanyard. The user slings the badge holder around the user's neck via a lanyard. Some user like the option of latching keys and other items together with the badge holder for convenience. These action may cause the badge holder to rattle or get in the way of the user. One solution many users use is to put their badges in one's shirt pocket while the lanyard is still around their necks. This solution only works if the attire has a breast pocket.

One other way to bring around a badge holder is via a badge holder with magnetic plates. However, much effort is needed whenever one needs to bring their badge close to any mounted badge sensor.

US Patent 2006/0282993A1 describes an attachable magnetic clip and system for an identification badge; however, the application was general in is usage and it was not specific on how it can be used.

### SUMMARY

One objective of this invention is to allow the user to utilize both the benefits of a badge holder on a lanyard, and the magnetic features on the typical badge holder with magnetic plates.

This invention allows users to easily scan their badges onto wall mounted sensors easily while not letting the badge sway around the user's neck.

This invention allows user with no breast pockets to keep their badge holders from swaying while their badge holder hangs around the user's neck on a lanyard by clipping their badge in between the clothing's buttons.

### BRIEF DESCRIPTION OF THE DRAWINGS

This invention combines these two ways people carry their badge holders so that one can easily scan his or her badge onto any mounted scanner while not let the badge sway around one's neck.

FIG. 1 shows a typical user using the badge holder. The user will use the lanyard in connection with the magnetic clip to carry the badge holder. To prevent the badge holder from swaying, the user can clip the badge holder onto one's clothing.

FIG. 2 is a section view showing that the clip sandwiches the fabric of the clothes to prevent it from swaying. The clip's width is small enough that it is able to insert in between two buttons.

FIG. 3 shows that the clip is an extension of the badge holder and it contains a magnet. The badge holder has a magnet as well, and these two magnets act as the clip for the badge holder.

### DETAILED DESCRIPTION

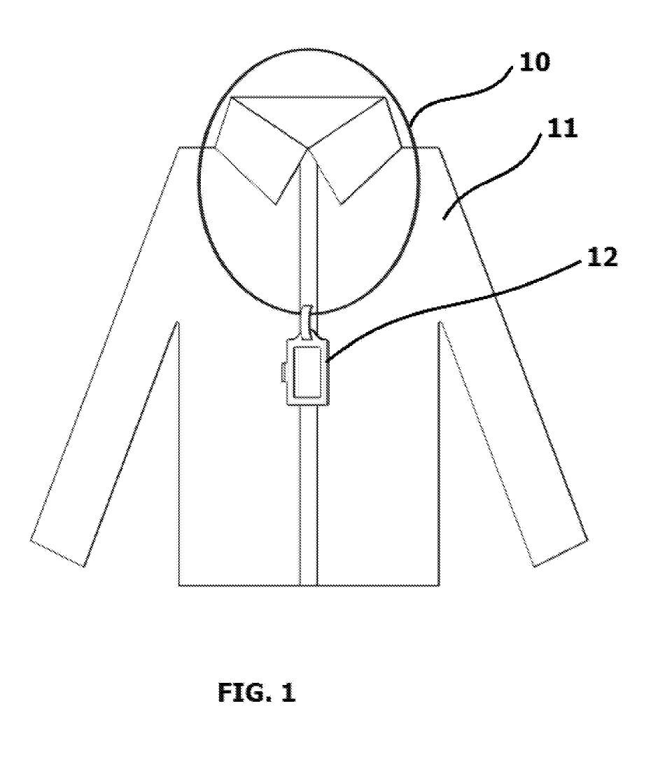

The present invention provides a magnetic clip to a badge holder with a lanyard attached to it. FIG. 1 shows a typical user using the badge holder 12. The user will use the lanyard 10 in connection with the magnetic clip to carry the badge holder 12. To prevent the badge holder 12 from swaying, the user can clip the badge holder 12 onto one's clothing 11.

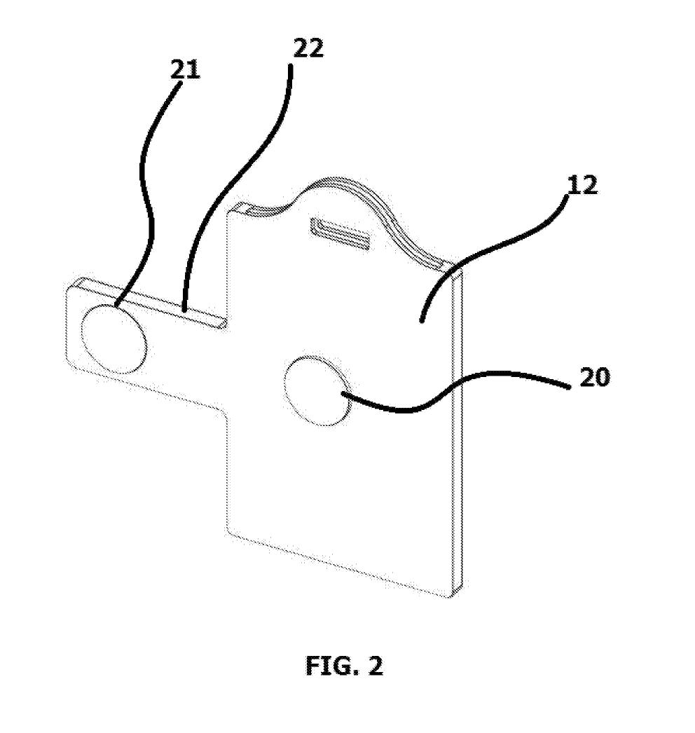

FIG. 2 shows the magnetic clip's 22 width is small enough to be inserted between two buttons on one's clothing 11 as shown in. The magnetic clip 22 will prevent the badge holder 12 from swaying when the badge holder 12 is being hung around the user's neck via a lanyard 10.

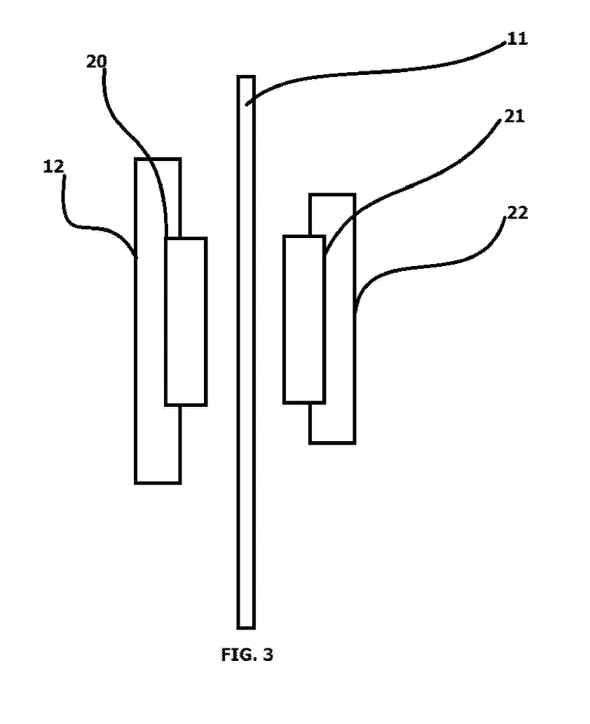

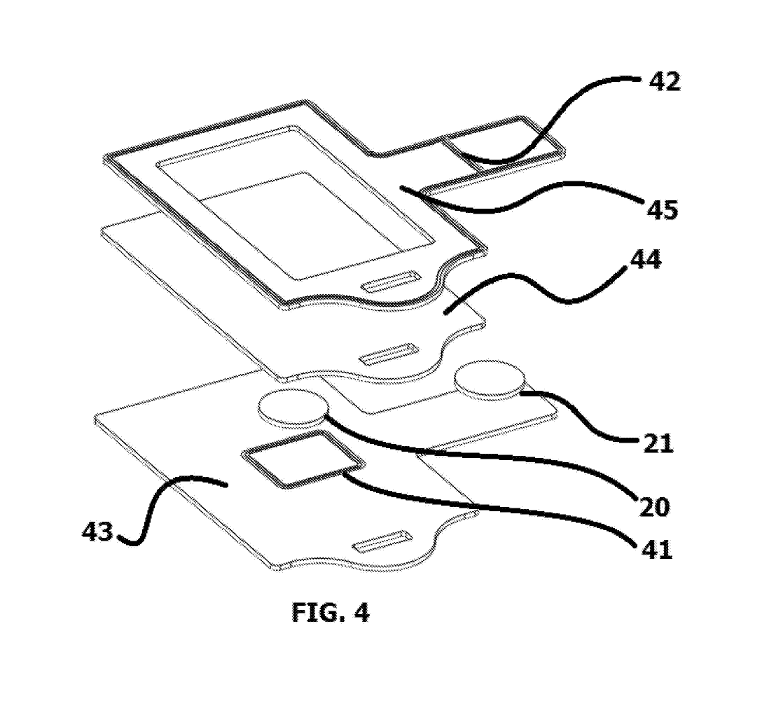

FIG. 3 shows that the clip is an extension of the badge holder 12 and it contains a magnet. The badge holder 12 has a magnet as well, and these two magnets 20 21 are the locking mechanism for the clip 22 of the badge holder 12. The faces of the two magnets 20 21 when faced together, as shown in FIG. 3 are to be of different polarizations. This is so that the two magnets 20 21 will be attracted to one another and can act as the locking mechanism.

The badge holder 12 is preferable made primarily from two pieces of leather 43 45, and a piece of fabric cloth 44 that are all stitched together with threads 42. Magnet 21 is stitched in between the two pieces of leather 43 45 and are held in placed by the stitches of the threads 42. Magnet 22 is stitched between the piece of fabric cloth 44 and the piece of leather 43. The threads 41 that stitch the leather piece 43 and fabric cloth 44, help to keep Magnet 22 in place. The two pieces of leather 43 45 may be made from other types of fabric cloth as well.

Clip 22 will be an extension of the badge holder 12, which is the extension of the two pieces of leather 43 45. and it may be cut out from the same leather with the badge holder 12.

The clip 22 may also be an added or detachable component for the badge holder 12.

1. A badge holder with a magnetic clip and lanyard comprising
a. a typical badge holder for lanyard with an additional clip behind the badge holder.
b. A clip with a magnet in it or is made from magnet.
c. A magnet behind the badge holder that will attract the magnet in the clip/magnetic clip. The magnet behind the badge holder is of a different polar from the magnet in the clip/magnetic clip.

2. The clip function according to claim 1 may be made from magnetic material so that a magnet is not necessary needed to be placed in the clip.

3. The typical badge holder according to claim 1 is made from leather.

4. The typical badge holder according to claim 1 is made from fabric.

5. The typical badge holder according to claim 1 is made from plastic.

6. The typical badge holder according to claim 1, holds the badge in portrait position.

7. The typical badge holder according to claim 1, holds the badge in landscape position.

8. The typical badge holder according to claim 1, is able to hold the badge in either portrait or landscape position.

9. The magnets according to claim 1 will keep the badge in place by sandwiching the fabric of one's clothing.

10. The clip according, to claim 1 consists of one or more magnets.

11. The badge holder according to claim 1 consists of one or more magnets.

12. The magnet behind the badge holder according to claim 1 is detachable.

13. The clip according, to claim 1 is detachable.

14. The magnet behind the badge holder according to claim 1 is, detachable via one or more buttons.

15. The clip according, to claim 1 is detachable via one or more buttons.

16. The magnet behind the badge holder according to claim 1 is detachable via one or more hook and loop tapes.

17. The clip according, to claim 1 is detachable via one or more hook and loop tapes.

18. The clip according to claim 1 is adjustable so that it can be on either sides of the badge holder.

19. The clip according to claim 1 is adjustable so that it can be on either sides of the badge holder via a button.

20. The clip according to claim 1 is adjustable so that it can be on either sides of the badge holder via a pin system.

21. The clip according, to claim 1 is adjustable so that it can be on either sides of the badge holder via a hinge system.

22. The clip according to claim 1 is adjustable so that it can be on either sides of the badge holder via a detachable and attachable method.

23. The width of the clip according to claim 1 is small enough to slip in between the buttons of the clothing.
